(19) United States
(12) Patent Application Publication
(10) Pub. No.: US 2020/0351561 A1
(43) Pub. Date: Nov. 5, 2020

(54) INTEGRATED SOCIAL NETWORK AND MEDIA STREAMING PLATFORM

(71) Applicant: Taylor A. Spencer, Santa Monica, CA (US)

(72) Inventor: Taylor A. Spencer, Santa Monica, CA (US)

(21) Appl. No.: 16/864,595

(22) Filed: May 1, 2020

Related U.S. Application Data
(60) Provisional application No. 62/843,154, filed on May 3, 2019.

(51) Int. Cl. H04N 21/4788; G06Q 50/00; H04N 21/835; H04N 21/81; H04N 21/4782; H04N 21/472

(52) U.S. Cl. CPC H04N 21/4788; G06Q 50/01; H04N 21/47202; H04N 21/812; H04N 21/4782; H04N 21/835

(57) ABSTRACT

A system, method, and platform are disclosed that may be configured and optimized for capturing or leveraging social interactions related to or associated with viewing of video, such as film media and television, and other streamed content including but not limited to books, podcasts, audio, and the like. Data mined during user interaction with the system may be leveraged for monetary rewards or other benefits.

### CROSS-REFERENCE TO RELATED APPLICATION

This application claims the benefit of U.S. provisional patent application Ser. No. 62/843,154, filed May 3, 2019, the disclosure of which is hereby incorporated herein by reference in its entirety.

### FIELD

Aspects of the present disclosure are related generally to social media platforms, and more specifically to a system, method, and platform that may be configured and optimized for capturing or leveraging social interactions related to or associated with viewing of video, such as film media and television, and other streamed content including but not limited to books, podcasts, audio, and the like.

### BACKGROUND

Social media websites began in or around 2003, with the introduction of websites such as MySpace™ and, then in 2004, the launch of Facebook™. Subsequently, new social media platforms, like Twitter™ and Instagram™, have found respective audiences or user bases interested in sharing or transmitting short messages as well as photo-based messages and related data or other content curated around such messages. All of these conventional websites and similar services have a common core functionality, namely that they allow users to create content and then allow other users (or subscribers to a respective service) to interact with such user-generated content.

New social media websites having new connectivity platforms and APIs that are unique (as compared to those offered by existing providers or distributors of content) are needed, not only to continue to expand the reach of social media, but also to recapture some of the lost personal interactions that were prevalent before the introduction of social media. Herein, certain embodiments define new social media platforms and concepts that facilitate capturing content, on the one hand, and consuming film and television content, as well as other video or streamed content, on the other hand.

Additionally, conventional methodologies do not contemplate mining data during users' interaction with the system such that those data may be leveraged for monetary rewards or other benefits; such data mining may improve platform functionality and ultimately benefit the users, the system, and the operator of the platform.

### SUMMARY

The present disclosure is directed to aspects of social media platforms, in general, and specifically those platforms comprising application programming interfaces (APIs) to facilitate connection of one or more users to streamable content as well as broadcast content, and to accommodate consumption of such media in a controlled, efficient, and user-centric manner.

In one embodiment, a system is disclosed comprising: a computer having a processor and memory suitable to execute computer readable software; and an application having a graphical user interface (GUI) and at least one user profile; the user profile having API connectivity to at least one platform enabling access to streamable media; wherein the profile provides a user an ability to search or watch the media via the application as a portal to a media streaming platform and to share user-generated content via the user profile within the application.

In one embodiment, the system comprises a plurality of users; each user having a rating system for media; wherein the application collates the rating systems generated by the plurality of users to generate a recommendation to each user based upon data generated by the user and comparisons to other users with the same or similar data profiles. In this manner, artificial intelligence (AI), machine learning, deep learning, or other heuristics can be utilized to generate recommendations from several vantage points, first, as to a real personal friend; second to someone who is followed (who also may be a friend); and third to other similarly situated profiles, using AI to identify content.

In another embodiment, the system comprises a plurality of APIs in order to allow the application to interact with at least two different media platforms; wherein content from a media platform and permissions as to access are imported to a user profile; and wherein content is recommended based upon the content that is accessible to a user via the media platform.

In some embodiments, the system recommends content to a user that is accessible to the user based on current permissions.

In some embodiments, the system recommends content to a user that is beyond a pay wall to the user, based on current permissions.

In a further embodiment, the application comprises a watching room, wherein the watching room allows for connecting between two or more users, who can simultaneously watch media and also have connection between the users, via text, chat, or video, in order to participate together in viewing the media.

In a further embodiment, a social media platform for consuming media is disclosed comprising: a plurality of user profiles; each user profile having at least one data point corresponding to available access to one or more media content providers; a database system identifying content from the media content providers and identifying content available for consumption therein; and wherein the plurality of user profiles can generate curated content of media and make recommendations associated with the content for consumption.

In a further embodiment, a social medial platform is disclosed wherein recommended media content is checked against the at least one data point to confirm available access.

In a further embodiment, a social medial platform is disclosed wherein access is confirmed when the at least one data point gives access.

In a further embodiment, a social medial platform is disclosed wherein the at least one data point does is not sufficient to confirm available access and wherein a user may pay for access.

In a further embodiment, a social medial platform is disclosed wherein use of the platform can be monetized by actions on the platform.

In a further embodiment, a social medial platform is disclosed wherein the monetized actions on the platform can be utilized to provide access to the system.

In a further embodiment, a social medial platform is disclosed wherein the curated content of a user profile associated with one user functions as a channel, wherein the channel can be consumed by another user on the system.

In a further embodiment, a social medial platform is disclosed wherein “n” number of users can watch a particular curated content from a user profile.

In a further embodiment, a social medial platform is disclosed wherein an invitation (or “invite”) can be sent between a first user and a second user to consume media content at a predetermined time.

In a further embodiment, a social medial platform is disclosed wherein a live feed of a user can be provided on the user's profile while the user is consuming curated content.

In a further embodiment, a social medial platform is disclosed wherein a user can make a recommendation to content, and wherein the recommendation is quantified within the system.

In a further embodiment, a social medial platform is disclosed wherein user recommended content is tracked based upon a time the content was consumed on a platform, and wherein the time is factored into the quantified value of the recommendation.

In a further embodiment, a social medial platform is disclosed wherein a number of recommendations and a number of users watching the recommended content is factored into the quantified value.

In a further embodiment, a social medial platform is disclosed wherein live programming can be consumed as a social grouping by sharing video of each user within a group.

In a further embodiment, a social medial platform is disclosed wherein private platforms can be generated, and wherein the private platforms can display content for consumption by one or more users.

In accordance with some aspects of the disclosed subject matter, an integrated platform may generally comprise: a profile management application that maintains a plurality of user profiles; each respective one of the plurality of user profiles associated with a respective user of the integrated platform and including data representative of permissions granted to the respective user enabling access to content on a media platform; a permissions management application that determines the respective user's permissions, wherein the data enable identification of content from the media platform that is selectively available for consumption by the respective user; and a curated content management application that maintains curated content, wherein each respective user is enabled to curate content from the media platform in the respective user profile and to engage in communications associated with recommendations regarding the content.

In some implementations, the permissions management application may check content that is recommended to a respective user against the data to confirm available access for the respective user. The permissions management application may confirm access when the permissions granted to the respective user provide permission to consume the content. In some situations, e.g., when the permissions granted to the respective user do not provide permission, the permissions management application may deny access pending further action by the respective user.

An integrated platform may further comprise a monetization application that enables the integrated platform to monetize the respective user's interactions with features. By way of example, the interactions may comprise providing user credentials for the integrated platform to collect the data, providing special permission for the integrated platform to collect other data associated with the respective user, curating content, consuming content, viewing advertisements, and engaging in communications associated with recommendations. As another example, the monetization application may enable the integrated platform to monetize by providing to the respective user one of subscription rebates, free or subsidized access to content, reduced advertising or advertising-free content, or cash rewards. Additionally or alternatively, the monetization application may enable the integrated platform to monetize by selling the data, the other data, or both.

An integrated platform may further comprise a consumption application that enables the curated content in the respective user's profile to be consumed by an arbitrary number of other respective users simultaneously; the consumption application may enable any respective user to provide a live feed to the other respective users as the curated content is being consumed.

An integrated platform may further comprise a data mining application that enables the integrated platform to retrieve at least one of use data from the media platform and device data from a device associated with the user, and may store the use data and the device data in the respective user's profile. In some implementations, a monetization application may monetize the use data, the device data, or both.

In accordance with another aspect of the disclosed subject matter, a system of organizing and monetizing user data may generally comprise: a computer server hosting an integrated platform, the server comprising: a processing component; and a memory component comprising instruction sets to enable functionality of the integrated platform, and a database operatively coupled to the server and having access to the memory component; wherein the integrated platform is operatively coupled to the memory component and to the database, and comprises: a profile management application that maintains a plurality of user profiles; each respective one of the plurality of user profiles associated with a respective user of the integrated platform and including data representative of permissions granted to the respective user enabling access to content on a third party media platform; a permissions management application that determines the respective user's permissions, wherein the data enable identification of content from the third party media platform that is selectively available for consumption by the respective user; a curated content management application that maintains curated content, wherein each respective user is enabled to curate content from the media platform in the respective user profile, to engage in communications associated with recommendations and consumption regarding the content, and to present the respective user's curated content and live feeds in a channel format to other respective users; and a data mining application that enables the integrated platform to retrieve at least one of use data from the third party media platform and device data from a device associated with the user, wherein the use data and the device data are stored in the database.

In some implementations, the integrated platform may further comprise a monetization application that enables the integrated platform to monetize the use data, the device data, or both.

An integrated platform may further comprise a recommendation application that employs the respective user's interactions to recommend content to the respective user; the recommendation application may allow the respective user to provide a recommendation of content to other respective users and may employ the other respective users' interactions to assess a value of the recommendation.

In accordance with yet another aspect of the disclosed subject matter, a method of organizing and monetizing user data may generally comprise: maintaining a plurality of user profiles in a memory component accessible by an integrated platform; each respective one of the plurality of user profiles associated with a respective user of the integrated platform and including data representative of permissions granted to the respective user enabling access to content on a third party media platform; retrieving at least one of use data from the third party media platform and device data from a device associated with the user; populating the respective user profile with the use data and the device data; identifying content from the third party media platform that is selectively available for consumption by the respective user; responsive to the identifying, allowing the respective user to consume and to curate content from the third party media platform in the respective user profile and to engage in communications associated with recommendations regarding the content; and responsive to the allowing, monetizing the use data and the user data .

Such a method may further comprise allowing the curated content in the respective user's profile to be consumed by an arbitrary number of other respective users simultaneously, and may even further comprise allowing any respective user to provide a live feed to the other respective users as the curated content is being consumed.

### BRIEF DESCRIPTION OF THE DRAWINGS

FIG. 1 is a high-level functional block diagram illustrating elements of one implementation of an integrated social network and media streaming platform.

FIG. 2 is a flow diagram illustrating aspects of one method of accessing content via an integrated social network and media streaming platform.

FIG. 3 is a flow diagram illustrating aspects of one method of private sharing of media content via an integrated social network and media streaming platform.

FIG. 4 is a high-level functional block diagram illustrating elements of one implementation in accordance with which users of an integrated social network and media streaming platform are enabled to find and to access content of another user.

FIG. 5 is a high-level functional block diagram illustrating elements of one implementation in accordance with which curated content of one user of an integrated social network and media streaming platform may be recommended to another user.

### DETAILED DESCRIPTION

The way people consume media (i.e., text, messages, graphic depictions, data, video, audio, and other materials or content) and entertainment has changed dramatically with the introduction of social media and streaming media platforms. In the context of the present disclosure, the terms “media” and “content” are generally meant to include, without limitation such text, messages, graphic depictions, data, video, and other materials, though it is noted that media may “contain” or comprise content, or vice-versa.

The computer-based data processing functionality and methodologies described herein are provided for illustrative purposes of example only and may be implemented by or in cooperation with any type of computer system or programming or processing environment, or by or in cooperation with a computer program, application, applet, plugin, daemon, or other instruction sets (i.e., “software”), executing independently or in conjunction with generic or special-purpose computers or other processing hardware or components. Specifically, aspects of the disclosed subject matter may be implemented in software stored or maintained, for example, on a computer-readable medium and executed as a computer program or application on a general purpose or special-purpose computer (such as a desktop or laptop computer, for instance), a tablet computer, a personal digital assistant (PDA), a wireless telephone, a network-connected television, or other device capable of bi-directional data communications such as those set forth below. For clarity, only those aspects of the system hardware and underlying functionality that are germane to operation of an integrated social network and media streaming platform are described, and specific details of hardware, networking and telecommunications functionality, data storage and memory access, encryption and data security or watermarking, and the like, that are well known in the art are omitted. Specifically, the computers, networking elements, and other functional hardware components are not described in further detail, though it will be appreciated that the disclosed subject matter is not limited to any specific computer language, program or application, or by the nature or operational characteristics of any particular computer or processing hardware. Those of skill in the art will also appreciate that an integrated social network and media streaming platform may be run, executed, implemented, or otherwise made available on or via a stand-alone computer system (such as a desktop computer or workstation, for example), or may be run from a remote or distributed server computer system; the specific computer hardware hosting or enabling the functionality, and the location or distributed nature of that hardware, is a design choice to be made based upon factors that are beyond the scope of this disclosure, so long as the integrated social network and media streaming platform may be accessed by a plurality of client (or remote) computer systems, for instance, via a local area network (LAN) such as an intranet network, a wide area network (WAN) such as the Internet, a cellular or satellite network, or any other networking paradigm that contemplates the bi-directional data communications set forth herein.

In addition, many features of an integrated social network and media streaming platform have application to a wide range of media, though some applications or commercial embodiments may focus on the sharing of video media; references to video media, movies, television programs, series, or shows are not intended to limit the scope of the disclosed subject matter, which is equally applicable to text, graphics, and other forms of media that are susceptible of transmission or sharing by or amongst users. To the extent that the present application discloses or references a “system,” such references are intended to mean an integrated social network and media streaming platform (“Integrated Platform”), as well as its associated hardware, any methods implemented by that system hardware, and software executed as a computer program or application to perform the method. Similarly, to the extent that the present application discloses or references a “method,” unless the context dictates otherwise, such references are intended to mean a series of processes executed by an Integrated Platform.

In accordance with some aspects of an Integrated Platform, accesses between a user's home page (i.e., on the Integrated Platform) and external systems (e.g., third-party websites or media servers) that provide content are provided through an application programming interface (API) such that the Integrated Platform functions as a portal into such third-party servers or native applications. Specifically, many third party websites, media servers, and other networked resources provide or make available APIs to allow other remote networked devices or components (such as software associated with or executing on an Integrated Platform) to “hook in” or otherwise access local resources or content. In the context of the present disclosure, the nature and operational characteristics of such APIs are not as important as the fact that they exist, and are conventionally used to share access across disparate resources coupled via a network. The disclosed subject matter is not intended to be limited by any particular API or by its functional peculiarities.

It will be appreciated that a web-based or other services platform (such as a social network, a media streaming service, or an Integrated Platform) designed to serve users may generally require enrollment, subscription, or some other form of registration on the part of each user; while some visitors may be allowed to browse or view some limited universe of content available via such a platform (e.g., to research the services offered, to decide whether to enroll, and the like), full or premium functionality of the platform is typically only offered to registered users. This allows the platform owner or operator to differentiate between users, allocate resources such as bandwidth and memory space, collect fees, limit access for unregistered visitors, and the like. In the context of the present disclosure, references to an Integrated Platform “user” are intended to mean a registered or enrolled user that is uniquely identified in and by the system. In that regard, a registration or enrollment process typically includes the user providing information such as a name, billing address, telephone number, social media profile data (or a hypertext link, user credentials, or other data associated with same through which the social media profile may be scraped or imported), credit card number, preferred user name or alias, password, etc. Such enrollment or registrations processes are generally known in the art, and the present disclosure is not intended to be limited to any particular registration paradigm, though it is noted that in some implementations, registration for full use of the Integrated Platform may be required, as is typical in the industry.

Such registration or enrollment may allow an Integrated Platform to generate a user profile that is unique to each user; as noted above, this user profile includes personal information that is either provided by the user directly (e.g., input responsive to a form or questionnaire provided during or after the registration process), imported or scraped from another platform (e.g., via an API, and aided by user credentials or other data associated with the user's profile, such as the user name and password used at the other platform), or acquired through specialized access granted by the user (e.g., via contact lists, text messages, electronic mail content, photographs, metadata resident on a computer or wireless device, and the like). An Integrated Platform may use such a user profile, or a subset of data associated with the user profile, to create a “home” or main page that is unique to each user; this is typical in the social media platform space. A home page may be accessed via an address (such as a uniform resource locator, or URL) on the world wide web, through a mobile, desktop, or browser application, or via any of various other access methodologies generally known to those of skill in the art. Home page access is typically password-protected or governed by biometric or other security measures to prevent unauthorized access. In a typical social network or media streaming platform environment, a home page acts as a portal or entry point into the platform that provides a user-specific location for creation, manipulation, storage, and management of certain data that enables the platform to create and share content on behalf of the user who is associated with the home page.

Accordingly, to engage such a portal embodied in a home page, a user of an Integrated Platform must generally employ a computer; in this context, a “computer” is intended to be broad enough to encompass a desktop computer or workstation, a laptop computer, a PDA, a wireless telephone, a tablet computer, or the like) having a user interface to enable networked bi-directional communication. In that regard, a computer may include at least one processing unit and a memory storage component for storing software, instruction sets, libraries, data, and the like. In the disclosed implementations, and as is known in the art, the memory storage component generally is embodied in or comprises or includes a program product (such as a hard disk drive, a solid state disk such as Flash™ memory, random access memory, or the like) including a machine-readable set of instructions that cause, when executed, the computer to perform steps. The program product may include software which may either be loaded into the computer or accessed by the computer; for example, the software may include an application on a smart device or mobile computer. In some implementations, software supporting or providing system functionality may not be resident on a user's computer, but rather may be accessed remotely by the computer, for example, using a web browser or other generic parser capable of retrieving instructions via hypertext markup language (HTML) text or other conventional markup language scripts. In that regard, the computer may access the software via the internet, an extranet, intranet, host server, internet cloud, and the like, as is typical in social networking or media streaming applications.

By way of background, there is currently a massive vacuum within the video streaming platform space insofar as conventional approaches do not accommodate users' optimizing and curating content for consumption for themselves and for other users. According to some researchers, there are 500 (and more) scripted television series that fill television and web-enabled screens each year, and those represent just the mainstream opportunities for consuming content in English. Many more series exist, when taking into consideration a global footprint and expanding the content universe to include other languages and cultures. By some estimations, consumers spend an average of 18 minutes a day making decisions on what content to view, leading to a massive waste of time and resources.

To date, the dilemma of “what to watch” (or what channel or show to watch next) has typically been resolved simply through “recommendations.” In some commercial implementations, such recommendations are provided by proprietary (i.e., not universal, integrated, or necessarily unbiased) AI algorithms trained by or based upon prior viewing habits. Conventional recommendations are deficient in several respects, however, primarily because they are simultaneously both too narrow and too broad. For instance, because each specific AI algorithm is proprietary and informed only of viewing habits (or content consumption) on its associated specific platform, the AI engine cannot benefit from content consumed by the same user on other platforms; accordingly, each particular platform (e.g., Apple™ TV, HuluTM NetflixTM, and the like) has only a limited universe of behaviors from which to draw inferences, making the recommendations, by design, too narrow for a typical user. Conversely, especially in the case where multiple users tend to use the same or similar account, the AI engine may have no way to differentiate the users, and hence can conflate the multiple users' preferences and viewing behaviors. In that regard, a family with four members (say, a mother, father, and children ages 4 and 10), is likely to have four completely different viewing histories, though the AI engine is only aware of one “user” (i.e., the family as a whole). In addition, sometimes users share passwords with other individuals, thus clouding the registered user's viewing behavior. Such a situation may confound AI learning, and thus may lead to an abundance of overly broad (and possibly conflicting) data, making it difficult for such a system to make useful suggestions or reliable recommendations that are appropriate for each potential family member in the audience.

Furthermore, current AI techniques employed by streaming services or other content providers cannot identify an individual user's emotions at any given moment, nor is it always possible to draw accurate inferences from current behavior. While in one week, a user's mood may suggest that a comedic selection or a horror movie with a loved one is an appropriate selection, in a subsequent week, that same user may be in a completely different frame of mind (i.e., the user may be recovering from a break-up, grieving the loss of a relationship, etc.) and exploring a completely different genre of content to overcome grief. One can imagine many different instances in which feelings and emotions are changed, resulting in very different consumption patterns as compared to a prior instance in time.

Aspects of the integrated social network and media streaming platform (“Integrated Platform”) described herein satisfy certain unmet needs of current technologies, providing a user with curated programming content based upon a social network of friends and influencers. In some implementations, the Integrated Platform may not only allow or otherwise facilitate a user to be exposed to something great (e.g., a new niche content), or to formats and media that were previously undiscovered, but also to participate or share in a societal experience (e.g., by simultaneously sharing with others while consuming the media).

Accessing the Integrated Platform, a user may find shows or other content recommended by friends, a show or other content having a positive review or rating, a show or other content that is popular with or amongst all users, a select group of users, a group of friends or network contacts, or a particular user. Accordingly, the disclosed Integrated Platform may solve or mitigate the issue of users finding it difficult to identify high quality content and managing or curating that content for consumption by a wide variety of other users.

In certain applications, curated repositories or lists, for example, maintained in, or in connection with, users' profiles may be searchable (both by the user maintaining the lists and by other users with appropriate permissions) and thus may become analogous to a cable television channel, radio station, library, or the like. In this manner, a user profile associated with or maintained by a particular actor, athlete, politician or political party, celebrity, organization, or any other individual or entity may display or make available content related to that person's (or entity's) interests; by “following” or subscribing to the profile of such and individual person or entity, another user may view the lists and access the content in the followed party's profile (i.e., the followed party's curated content).

In operation, upon logging in to the Integrated Platform, a user may search for specific content, browse content (e.g., type of media, genre, specific actors, authors, or performers), search for or browse through lists of other users, and may follow other users, if the other users provide appropriate viewing and access rights—in some situations, a particular user may set permissions such that the user profile is only visible to friends, network contacts, or some other subset of all system users. The act of following, as is generally known, typically allows the following party to view and to access content, messages, updates, and other information provided by the followed party. In some respects, this functionality is part of the social networking aspects of the Integrated Platform, and each user's respective home page allows interaction with followers, while other features of the software allow the user to follow others.

While using the Integrated Platform, a user may generally browse, toggle, or “flip” between different followed parties' profiles to find different curated content, each respectively associated with a respective followed party. A user may also define, maintain, or curate a queue, playlist, or other ordered list by identifying new content to watch or consume, or by finding other previously curated content; the content in any user's queue or list may be either selected from the user's own profile or cribbed from a followed party's profile (or it may be recommended by an AI engine, for instance, as typically presented in a “Recommended for You” list or similar feature offered by several media streaming applications). For example, a user may maintain curated content of the 10 best episodes of a favorite show, which may be presented or played in an order revolving around or associated with a certain plot line, by popularity, by date of first airing or by date on which the content was added to the curated list, or for some other reason. This list of only 10 items of content may be supplemented via content available from the user's own profile, or via content available via a followed party's user profile.

In the context of an Integrated Platform, all content may be stored, and it may be categorized as passive, on the one hand, or live, on the other hand. For example, a previously recorded television show or previous published book may be viewed, as demand defines, by the consumer, for instance, by selecting and confirming a date and time to consume the content (at which point the system will stream the content at the appointed time), or by selecting the content to be accessed immediately (e.g., by selecting a “Play Now” button or other feature in a graphical user interface (GUI)). This may be categorized as passive content, meaning that the user has discretion and control over when recorded and previously stored content is accessed. Some users prefer to consume certain media live under some circumstances. For example, a sports game, a performance at the opera, an outdoor concert, a streamed lecture, a political debate, etc., may have a temporal aspect that excites or intrigues users for a variety of reasons. While content associated with such live events may be saved and consumed at a later date and time (as noted above), it may also be consumed in the present moment by users who so desire. Thus, flipping through different user profiles or followed party profiles may reveal content that is stored or is live currently, or is scheduled or queued to be viewed live as the event is happening.

For some consumers, the social aspect of content consumption has been destroyed by on-demand programming, as technological advances and viewing options have enabled users to forgo face-to-face, personal contact and relationships, and to forge ahead in the privacy of their own homes. This relative isolation has eliminated, or at least greatly reduced, the personal interactions that existed when friends would assemble together in the same room to watch a show, watch a pay-per-view event, or otherwise to consume such media. The disclosed Integrated Platform may enable users to flip through channels (e.g., their own or a followed party's) and to watch a program or to consume other content with another user; specifically, content consumption and digital interaction between parties may occur simultaneously via a single Integrated Platform. Thus, where a first user follows a second user, and the second user is consuming a baseball game, the first user, clicking through profiles, finds the second user's profile, and, following a link to access such content, watches the game too. In this example, there may be personal interactions between the two users, or there may be none, depending upon the preferences of the users at the time. Thus, one user may consume content with (i.e., at the same time as) another person who is a followed party. In certain embodiments, each respective user (or a subset of users) in a group simultaneously consuming the content may also live stream a respective environment, and thus real-time reactions to a show, a sporting event, or other content (whether passive or live) may be consumed together and shared amongst all live streaming users in the group. Thus, in game 7 of the world series, fans of one team may celebrate together or commiserate with each other in defeat, depending upon the fans' perspective. Fans may cheer on their favorite athlete (or their favorite country) at the Olympic games, or join together to watch a player draft. In other spaces, fans may watch a drama together, and gossip or speculate amongst themselves as a major plot point is revealed. This virtual viewing room allows the users to connect with one another and to share experiences as well as to find media that is desired.

An Integrated Platform capable of the foregoing functionality may generally comprise several features. Some details of some implementations are provided below by way of example only, and not by way of limitation.

Social Network Functionality:

As set forth herein, a simple, social networking platform may allow a user to: curate a profile; engage with other users; post and manage content; post recommendations (e.g., for content, influencers or other users, actors, authors, etc.); vote; share ideas and stories; and the like. By curating an individual profile containing lists and access to content, each registered user may then further engage with additional users (and their content across multiple media streaming platforms), and the system will be better able to utilize AI learning, machine learning, deep learning, or other heuristics to generate additional content for recommendation back to the user. Access to multiple user profiles (and to followed parties' curated content) may allow a user to identify content from friends, network contacts, and other users as if those friends and other users were channels.

Recommendations:
General and personal recommendations (either from another user or from an AI-based recommendation engine) may be sent, posted, or generated to or by a user's profile
User-to-user recommendations may be transmitted via an in-app or Integrated Platform hosted messaging system or via public posting (i.e., broadcast to all system users)
System-generated recommendations may be informed by or established through a user's follow and click-through activity, the nature and genre of consumed content, as well as a data driven code for curated content
Recommendations may facilitate creation of an easy to use content identification and consumption system that users will enjoy
Recommendations allow and incentivize interaction with content creators, recommenders, and other fans
Recommendations may be related to free content and and to paid content behind a firewall

Integrated Platform Profile:
General Homepage—may integrate sponsored content, recommendations, and personal and general user activity from engagement (i.e., registration with the system)
Personal Profile—may track content consumption, providing a calendar of favored content along with relevant news, posts, and interactions
Activity Feed—may display and track activity of followed parties and their pages
Privacy Filters—may ensure that only approved content is viewed by the user owning the profile or displayed to the public or other system users
Users may view or consume recommended content, or make recommendations to following parties or other users

Viewing Content:
Links to the content may be provided on the Integrated Platform, via a particular user's profile or home page; access to the content may be provided either through software on the Integrated Platform or directly via the provider (or source) platform, but access from the source may be tunneled through the Integrated Platform
APIs may be used to connect to the content at a particular media streaming source—depending on the user's access rights with the media streaming source, the content may be played or viewed through the Integrated Platform software or on the host's or source's platform
Content Coverage—no one single medium or media streaming platform may allow for broad content coverage and improved AI learning characteristics
Content may include offerings from television, film, articles, shorts, web videos, webcasts, and more
Users may recommend and discuss content via chat, message, or other telecommunications applications within the Integrated Platform
Private viewing rooms may define spaces for users to consume content together in a virtual environment as noted above

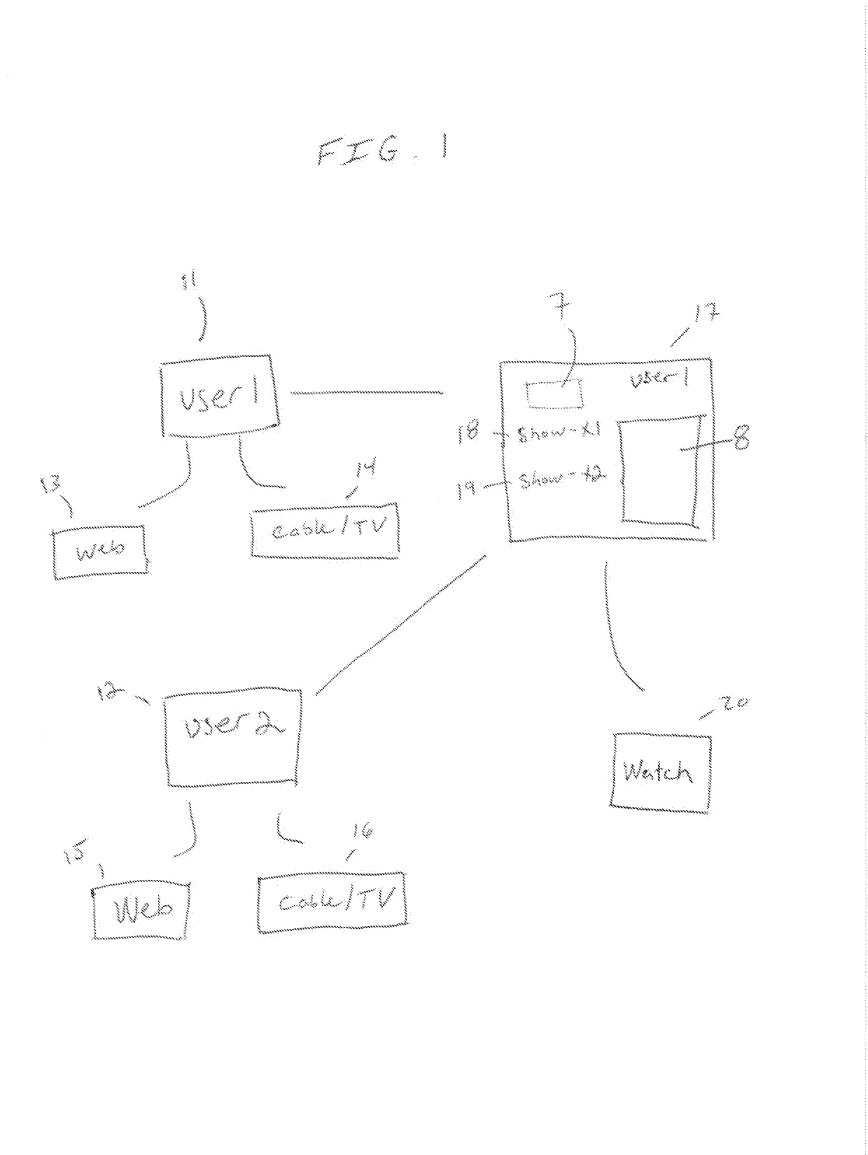

Turning now to the drawing figures, FIG. 1 is a high-level functional block diagram illustrating elements of one implementation of an integrated social network and media streaming platform. As indicated in FIG. 1, user 1 (reference numeral 11) may connect or couple one or more media streaming platforms 13 and 14 to the Integrated Platform described above. This may occur during the registration process, or later, for example, at the user's convenience or following subscription to a new streaming platform. Such a coupling or connecting of media platforms 13 and 14 to the Integrated Platform may include providing a software application resident at or accessible by the Integrated Platform with a user name and password (e.g., user credentials) for each respective media platform 13 and 14, such that the Integrated Platform may use the user credentials to access each respective media platform 13 and 14, via an appropriate API, to acquire profile data, viewing queues and viewing history, favorites lists, and the like for importation to the Integrated Platform. By connecting or coupling media streaming platforms 13 and 14 and collecting (or “scraping”) the profile data and content resident at each, the Integrated Platform, in general, and a user's public profile or home page 17, in particular, may become a hub, or central location, for aggregated content (or at least curated lists of content) from a plurality of disparate sources and providers. Such content, that would ordinarily only be accessible via independent sites or media providers, may be managed and accessed from a single, centralized, Integrated Platform that provides a single locus for content consumption and social interaction related to the content.

In the context of the present disclosure, media platforms 13 and 14 may fall into one of two categories: (i) subscription web-based platforms (reference numeral 13) such as Netflix™ Hulu™, Amazon™, MLB.tv™, NFL Sunday Ticket™, and others; and (ii) cable, satellite, and other television providers (reference numeral 14) such as Comcast™, Direct TV™, Cox™ Verizon™, CBS All Access™, HBO Now™, and others. User 11 may watch a program, such as a television show, or consume some other content, such as a movie or sporting event, which may be streamed through or provided via a specific account maintained by Integrated Platform and uniquely associated with that user 11, and may maintain or curate such content on the Integrated Platform.

As used in the context of the present disclosure, the concept of “curating” content may mean or comprise a number of things. For example, the public profile or home page 17 of user 11 may display curated content 18 and curated content 19. For example, the curated content 18 and 19 may each represent a different series of shows that user 11 intends to watch (for example, a queue (the order or sequence of which may be user-defined or system-defined) of unaccessed or unwatched content); alternatively, curated content 18 may represent a queue of content that user 11 intends to watch but has not, yet, while curated content 19 may represent a different group or list of content that user 11 has already consumed in the past. It will be appreciated that both previously consumed and yet to be consumed content may be identified in the same list, and may or may not be differentiated, such as with highlights, flags, different colored text, etc. Additionally or alternatively, curated content may be embodied in or comprise recommendations or comments from a particular show; curated content may relate to an ongoing live show, for example, a then-occurring athletic event, or a then-occurring live TV program. In that sense, curated content 18 and 19 may be passive or live, or a combination of both. It will be appreciated that “curating” content includes, but is not limited to, sorting, ranking, ordering, managing, referencing, cross-referencing, and generally organizing content for consumption (either by user 11 or by other users or parties that follow user 11).

In the FIG. 1 example, the actual content currently being consumed by user 11 may be displayed in the display 8, such as may be implemented in a content window, frame, or other GUI element as is generally known in the art.

Additional created content may be present on public profile or home page 17, for instance, in a description or “additional information” window or frame (reference numeral 7, in FIG. 1). Additional information may include data or content provided by user 11, for instance, such as personal information, favorite content, favorite actors, and other information that makes user 11 unique or that which user 11 wants to share with followers or other users; additionally or alternatively, additional information displayed in window 7 may include advertising material or content recommendations provided, for example, by the operator of Integrated Platform, or by one or more of media streaming platforms 13 and 14. Integrated Platform may allow various users to share video, to share images or other content, and otherwise to personalize the information on public profile or home page 17 so that the depiction of the profile itself is a unique curation of individual user 11.

In certain implementations, it may be useful for curated content 18 and 19 to include a playlist (or queue) of content. Those of skill in the art will recognize that a playlist paradigm is commonly used in the music streaming space, where a series of songs or musical arrangements is generated, largely based upon user input or inference based upon user activity, and a user will then get to enjoy the concatenated list of content, either in a particular order or scrambled (or possibly a combination of both). The concept behind a playlist is that the particular content in that list has been verified by the consumer and is intended to be consumed under certain circumstances or when the user is in a particular mood or frame of mind. Thus, a music playlist generally may include songs that the user enjoys, or which the user expects to reflect or to convey a particular emotion or feeling. Thus, playlists often have a user-defined theme or associated mental state, such as sad, happy, tired, study, etc., a feature that is commonly found on current music sharing websites.

A similar concept may be applied to creating curated content in the context of an Integrated Platform such as describe above. A user may curate content regarding favorite shows, themes, emotions, etc., and associate that content with a particular mood, state of mind, or some event or circumstance (e.g., driving in cross-town traffic versus a day at the beach with friends). Thus, as depicted in FIG. 1, two different curated content lists 18 and 19, are depicted, each with a title. A first curated content 18 may include comedy shows from the 90's and include user 11's favorite shows and favorite episodes regarding that topic. A second curated content 19 may have a different theme and different content, which may similarly be defined by user 11. User 11's public profile or home page 17 may provide access to these curated content lists 18 and 19 (assuming that user 11 has provided such permission in an appropriate profile field or data record) to following parties or other users, for example, and such permissions may allow user 2 (reference numeral 12) to view the home page 17 and to evaluate content 18 and 19.

In the FIG. 1 example, user 12 may register with the Integrated Platform and create a profile identifying the third-party or other media streaming platforms on the web (reference numeral 15) and operated by cable or other television providers (reference numeral 16) to which user 12 is subscribed; it is noted that web media streaming platforms 13 and 15, and television media streaming platforms 14 and 16, may be the same or overlap, meaning that user 11 and user 12 may subscribe to the same or similar services. Upon login to the Integrated Platform and having access to other registered users' home pages, user 12 may be enabled to flip through different profiles of those other users, and may come across (or be directed to, via recommendation or otherwise) the home page 17 associated with user 11. User 12 may then view the curated content 18 and 19, and may also be able to view the content 8 currently being consumed by user 11 (if permissions from both user 11 and the applicable media streaming platforms 13 and 14 are appropriate, as noted above). If user 12 determines that content consumption histories and interests align with those of user 11, then user 12 may elect to follow the recommendations of user 11, and may then elect some content from curated content 18 or 19 to sample. In this example, user 12 may join user 11 in viewing content at reference numeral 8, or may decide to access content from curated lists 18 or 19 and consume such content independent of user 11 (this is depicted at reference numeral 20 in FIG. 1).

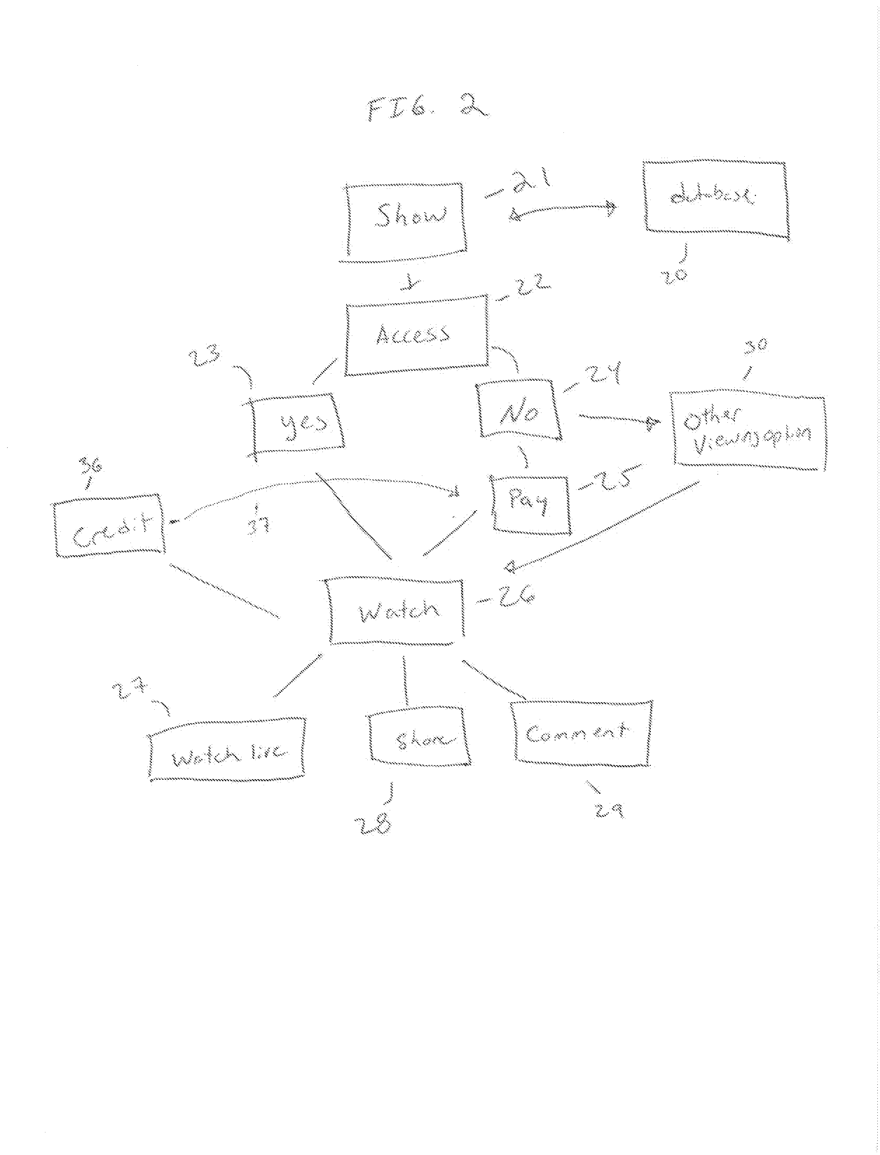

FIG. 2 is a flow diagram illustrating aspects of one method of accessing content via an integrated social network and media streaming platform. FIG. 2 depicts aspects of a method that may be implemented at the point when a user (such as user 12) decides to consume certain content from another user's curated content. As noted above, user 12 may have previously provided the Integrated Platform (either during registration or at a later time) with a list (as well as user login credentials) of the programming for which subscription fees have been paid, or with respect to which user 12 has otherwise acquired access or authorization to watch, through media streaming platforms 15 and 16. This allows the Integrated Platform to create a master list of all content that is resident on or accessible through platforms 15 and 16 for which user 12 has already paid. In many instances, however, some of the content that user 12 identifies via the Integrated Platform and may want to watch is content which requires an additional subscription. For example, in FIG. 2, user has identified a television or web-based show to watch (block 21), and may navigate through a GUI to watch the show. When the user “clicks” or otherwise manipulates an appropriate GUI mechanism to watch the show, the system may then determine whether the particular user (e.g., user 12) has appropriate permissions and a valid subscription to enable access (block 22). If yes 23 (the user has access), then the user is provided access and can watch the show (block 26), and the user is taken immediately to that programming or content. In the case that the user does not have access (block 24), however, then the user may simply be denied access with an error message, or may be queried with an option to buy access.

In some implementations, a user may buy access through the Integrated Platform just as the user would buy access to a movie theater or to add a new paid web platform 15 or paid channel on a cable box set 16, for instance, by agreeing to the purchase price of the show. Thus, within the GUI presented by software running at or accessible by the Integrated Platform, a notation may be provided that offers a mechanism through which the user is allowed to buy access. In certain applications, the purchase price may provide for a single episode or contemplate the user watching the content only once or for a limited period of time, i.e., renting the show. In other applications, the user may need or desire to buy more complete access to the content, for example, in the form of a daily pass, a weekly pass, a monthly, pass, etc.

As noted above, each provider of content (i.e., a media streaming platform) may be connected to or communicate with the Integrated Platform through an appropriate API, and each provider may choose to set prices in accordance with corporate policy, current or expected demand for bandwidth or other resources, content popularity, or a combination of these or a variety of other factors. For example, one provider may offer a reduced rate to a consumer based upon that consumer's selection of content through (or curated by) a specific or preferred user, celebrity, or influencer. In other instances, the content may be offered at the same price as would be offered in the consumer were purchasing the content through another website. In other instances, the price may be higher (or lower) than the price of the content as offered on other platforms. In some implementations, options for purchasing content (e.g., from the media streaming platforms, but via the Integrated Platform) may include rental, purchase, hourly, daily, weekly, monthly, yearly subscriptions, and the like. Once paid (block 25), then user 12 may be permitted to watch the show (block 26).

The example in FIG. 2 includes an alternative, or “other” viewing option (block 30). For instance, assume that user 12 has selected a show (at block 21), and that show is available on HULU™, but user 12 does not have a subscription to that service, and so a “No” access condition exists (at block 24). As indicated in FIG. 1, however, user 12 is a member of several web 15 and cable/tv 16 platforms, and each show and each platform is stored within a database on the Integrated Platform or accessible by or through the system (block 20 in FIG. 2). Accordingly, the database 20 contains a repository of different access platforms and different shows and content within those platforms. Because of the different access points, the same show may exist on two different platforms (say, both HULU™ and Apple™ TV, for instance) and thus a particular user of the Integrated Platform may have access via one platform, but not have access via another platform, for content that is available via both.

This situation is especially prevalent with regard to older content or cinema content that is released to the public after its run in a theater. Thus, in FIG. 2, responsive to a “NO” determination (block 24), software resident at or accessible by the Integrated Platform may query whether another viewing option is available for the same content (block 30). The database 20 can quickly identify whether there are other viewing options available, and the system may then revert to a “YES” determination (block 23) and provide access to a feed or stream, if available, with respect to which the user does have permission to view the content. Assuming that no other option is available, then the option to watch the program will be through payment (at block 25) as set forth above.

Once a user is watching, or is provided access to, the content (block 26), the user may be provided with the option to watch “live” (block 27), meaning that the content can be watched immediately, or the content may be accessed immediately but saved for consumption at later time. In that regard, a user might want to save content to a queue or playlist, consume the content immediately, or both; all three of these options are depicted in the “watch live” block 27. Additionally or alternatively, the user may share the content that is being consumed (block 28). For example, upon access content that the user enjoys, the user may then posts some message related to the content, and may be provided with the ability to post available clips (depending upon permissions) of or regarding the specific content so that others may be apprised of the content, and perhaps elect to watch. Similarly, the user may also be enabled via software of the Integrated Platform to provide comments (block 29). In this context, the term “comments,” broadly defined, is generally intended to include any writing or spoken words regarding the programming or other content. For example, a user may want to post a live feed as the user is watching a program, and then post a message or other text, blog, webcast, or the like when or after the some seminal or definitive event occurs. The user may want to post text regarding something positive or something negative about the content. Any such commentary, annotations, information, or other materials posted or provided by the user to the Integrated Platform and related to specific content (that is currently or has previously been consumed) is contemplated by block 29. The present disclosure is not intended to be limited by any particular mechanism or technology used to solicit comments from the user or used to provide, submit, post, or otherwise to transmit such comments to the Integrated Platform.

In the example flow illustrated in FIG. 2, the concept of earning credits is also depicted (block 36). Credits, sometime referred to as “points,” “tokens,” or “loyalty rewards,” may sometimes be awarded to a user for a number of activities. First and foremost, credits may generally be earned by watching content recommended by or retrieved from the curated content lists of another user, or by watching content in general, within the Integrated Platform. In that regard, credits may be earned as a function of, for example, the duration of time the user is active on (i.e., logged in to) the system, the number of complete episodes watched or other content consumed, the number of advertisements played or watched during content access, the number of advertisements on a user's profile, the number of following parties or followed parties associated with a user's profile, the user's act of making comments and recommendations, and otherwise generally interacting on the system and consuming content. In these and a variety of other ways, a user can earn certain credits that may be redeemed within the system. Those of skill in the art or active on social networks or electronic commerce sites will appreciate that the types of credits provided and the manner in which they may be acquired vary from site to site and from application to application; the present disclosure is not intended to by the limited by the manner in which an operator of an Integrated Platform rewards its users with credits or loyalty programs.

For example, if a user desires to watch a show that is not already in the user's paid profile (such that access is currently not permitted via the Integrated Platform), then the system may offer the user a further option to use accumulated credits (see block 36 in FIG. 2) that have previously been earned from use of the Integrated Platform to pay for that access. In certain situations, the accumulated credits associated with the user's account may be redeemed by the user in exchange for a partial or a complete payment for the access. In some implementations, a particular user's credits may also be transferred or given to another user for use in buying access to content, eliminating or reduce advertising, and the like.

Thus, by creating content, watching content, and interacting with the system, a user of the Integrated Platform may be able to earn credits that may be utilized to pay for (or to defray the cost of) content that would otherwise have required additional incremental costs to the user.

In certain situations, a user may choose to provide a recommendation regarding particular content, such as a television program, a film, or a webcast or blog. In its most basic form, and as it typically implemented in social networking contexts, a recommendation is, to some extent, a binary valuation of the program—namely that a user either recommends content or does not recommend content. In practice, however, the thought processes and decision-making actions that lead a user to provide a recommendation are more complex than a binary function. For example, the user must first decide whether to take some action (i.e., whether to provide a recommendation regarding) the content. In this context, deciding not to comment on the content is, itself, a choice. Second, the user must decide why the comment is appropriate, whether it addresses a global aspect of the content or addresses only a minor or ancillary point that does not affect the overall enjoyment of the content in a material way. Third, the user must decide how much information to provide, whether to include disclaimers, and the like. Those of skill in the art will appreciate that not every “recommendation” is exclusively positive in its treatment of the work in question. In that regard, recommendations may be positive, negative, or a combination of both (“I loved this film, but there is a gaping hole in the plot . . . ” or “The script was cliché, but my favorite actor pulled it off and made the movie enjoyable . . . ” are examples). Accordingly, neither the recommendation process itself, not the logic a user must navigate in deciding to recommend and to create the recommendation, is as binary as the typical “like” or “dislike” options might lead a user to believe.

In accordance with some implementations of an Integrated Platform, such recommendations may be quantified, but not necessarily in the same manner as a traditional point scale or rating system. In a typical scaling or rating system, users are invited to rate content, such as on a scale having a given range (e.g., 1-10, 1-100, 1-5, etc.); in practice, the score or rating is intended to provide other users with some context or guidance as to how the particular user providing the rating felt about the particular content. Unfortunately, such ratings are frequently unreliable for a variety of reasons. For example, users often give only high ratings if they like certain content, but do not bother to provide a rating at all if they do not like that content; this tends to skew ratings artificially to the positive side. As another example, some users post poor reviews if they dislike certain content, but that dislike is often not based exclusively on the merits of the content, itself, but on some other (e.g., social, political, or emotional) reason. Accordingly, conventional rating or ranking systems are often manipulated easily by real and fake users alike (e.g., by those with honest intentions and by those that are deliberately trying to sabotage the credibility of the system).

Instead, an Integrated Platform may employ software analytics and behavior tracking modules to identify actual recommendations (i.e., those that are not intended to be duplicitous or phony) and monitor the number of views, duration of views, number of additional concurring or dissenting recommendations, etc. that flow through a particular recommendation. In this manner, some implementations of the disclosed system may utilize a recommendation platform that gives further value to users by qualitatively (and quantitatively) assessing the merits of the recommendations. As noted above, such an assessment may be based upon the total views of the recommendation, itself, the total views of the recommended content, the duration of the views of the recommended content, the number of additional reviews that either support or contradict the original recommendation, or a combination of these and a variety of other factors that the Integrated Platform takes into account. For example, time may be used as a variable to identify the merits of the content, and thereby the value of the recommendation; in one such implementation, a situation in which a user watches recommended content from start to finish may prompt the recommendation platform to ascribe a higher weight or value to the original recommendation (suggesting a positive recommendation was more useful or more accurate), whereas when a watches only a portion of the content and then stops the viewing, the recommendation platform may ascribe a lower weight or value (to the positive recommendation). It is noted that the foregoing example may work the other way for negative recommendations—i.e., a short view time may validate the recommendation, whereas a long view time may tend to undermine or contradict the recommendation.

While third-party ratings systems (e.g., 1-100 and similar scales) may be utilized in certain situations, an Integrated Platform may employ such a recommendation platform to add value to users. Where the recommendations are more accurate, they are more useful. Accordingly, appropriate software scripts and behavior tracking to map user behavior subsequent to viewing a recommendation. Various inference engines and other software analytics may be employed to aggregate data collected from or associated with the recipient of the recommendation, both directly (e.g., in the form of feedback on the recommendation or in the form of an additional recommendation) and indirectly (e.g., in the form of time spent watching the content, reviewing more of the original recommender's recommendations or curated content, etc.). The functionality of the recommendation platform may be application-specific or selected as a design choice by the operator of the Integrated Platform; in some instances, access to qualitatively and quantitatively assessed recommendations may be part of a premium service offered by such an operator.

In a similar manner, a curated list of content may receive an associated value, for instance, assigned by or in cooperation with a recommendation the Integrated Platform. For example, consider the case in which a user has a curated list of comedy shows, and each show has been positively recommended numerous times and also has a high percentage of users who (following the positive recommendation) watch the entirety of the shows. An Integrated Platform, using a recommendation platform or engine as set forth above, for example, may track the actual time, other user behaviors or interactions, and employ algorithms or other analytics tools operating on such tracked or collected data to create rankings or ratings for the content itself, the curated list, or both, that are based on actual experience, user behavior, and watching habits. In the foregoing manner, the system may generate more reliable or accurate assessments of the content and the list as a whole, as compared to the commonly used but less reliable user-generated scores, which are typically based on subjective factors such as emotions at the moment regarding a particular content.

In accordance with some implementations, such ratings and other tracked information (for instance, regarding or related to recommendations, consumption of recommended content, actions taken responsive to recommendations, and the like) may be saved to both a relevant user's profile page and the main, master, or profile page associated with the content itself.

One aspect of human interaction that is facilitated by the Integrated Platform may be to encourage a return to the consumption of media content in the presence of others. As noted above, internet connectivity and on-demand content delivery have created a system that incentives consumption of media in the privacy of one's own home, at one's own convenience. Consumption of content in isolation, however, tends to reduce, or can entirely eliminate, the social interactions upon which relationships are built and that create traction (e.g., viewership or fan base that leads to advertising dollars) for certain content.

Before the internet was ubiquitous, users or fans of a show could gather together and watch content as a group (for example, at a pub or a single user's home). Consuming content as a group creates strong bonds between individuals and allows them to share the experience together.

The Integrated Platform provides a similar opportunity, though through the advent of connectivity between a user and cameras embedded in or associated with a computing device at the user's location. Thus, a user, having access to the Integrated Platform may watch or consume content simultaneously with other users, and each user is enabled to share aspects of the user environment. For example, a user may employ a “share screen” function or similar feature (familiar in video conferencing technologies) to broadcast to other users a visual representation of the user's display panel (including currently playing content) in real-time or near real-time; similarly, a user may employ a camera to stream the content being played or otherwise to share it with friends or network contacts. This allows for interaction, social engagement, and feedback between and amongst individual users that are simultaneously consuming content.

Take, for instance, the situation in which a group of people decide to watch a sports game together. At the end of the game, something great happens to one team, and all the users cheer and celebrate. Instead of doing this (in seclusion) in the privacy of one's own home, users of an Integrated Platform, even though physically separated from each other, may nevertheless share the experience with and among other users who are simultaneously experiencing the same emotional lift from the action in the game. Thus, while the individuals are not celebrating in the same physical space, they may still celebrate “together,” as one, and interact with each other virtually.

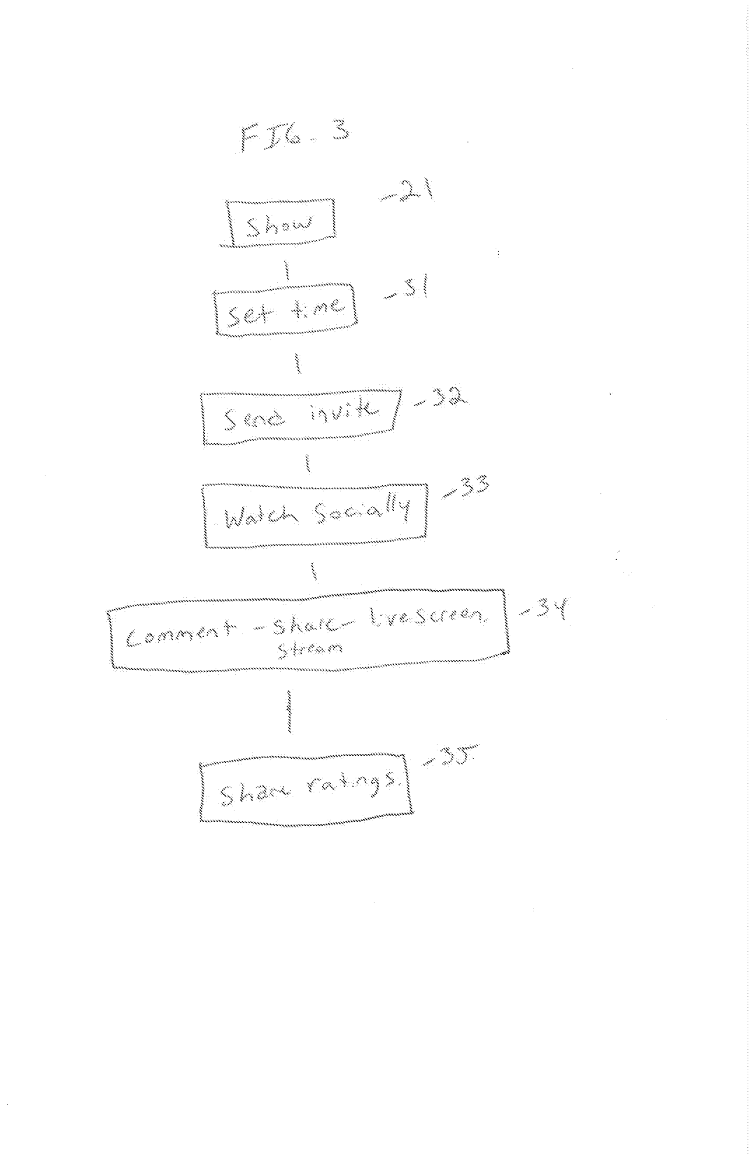

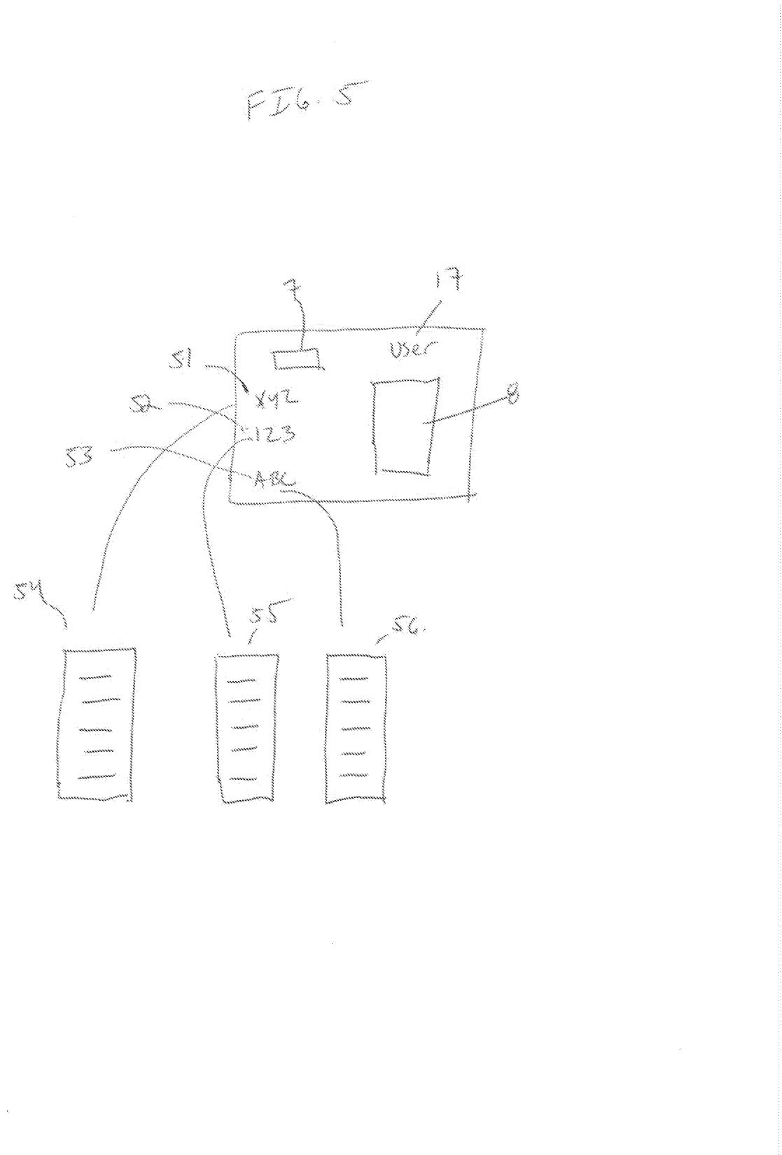

In that regard, FIG. 3 is a flow diagram illustrating aspects of one method of private sharing of media content via an integrated social network and media streaming platform, and FIG. 5 is a high-level functional block diagram illustrating elements of one implementation in accordance with which curated content of one user of an integrated social network and media streaming platform may be recommended to another user. FIG. 3 one example of how such a virtual meeting or viewing party may be implemented in a situation in which content of mutual interest may be identified (block 21), and a user may optionally set a time for viewing the content (block 31). For example, a show that is live television may have a specific time that it goes live; however, the meeting organizer, or the users, collectively, may decide essentially to “pause” (or time-delay) the show to begin at a later time. Thus, if a sports game starts at 7:00, but all users need or desire to delay until 7:30 to accommodate scheduling conflicts, for instance, or because of other obligations, they can pause the content until 7:30 and then watch together.

In other situations, the content that the group intends to view has previously been published or broadcast, occurred in the past, or is provided in an on-demand format; in these circumstances, when setting a time to consume content (at block 31), a user, individually, or the group of users, collectively, may select a start time that is convenient for anyone (or for everyone) wanting to consume the content together. A user organizing a viewing event may, through software running on or in association with the Integrated Platform, send an invitation (block 32) to other users; as is typical, such an invitation may include an identification or a description (or both) of the content and the intended start time, and users on the invitation distribution list may accept the invitation and join at the appointed time to watch socially (block 33). While omitted from FIG. 3 for clarity, the applications of FIGS. 1 and 2, as well as the functionality and supporting software execution described above, may be applicable in the operations depicted in blocks 33 through 35, and so where a user does not have access to specific content (such as show 21), that user may need to pay for access, redeem credits, or subscribe to a particular media streaming platform before access to the content is granted via the Integrated Platform as set forth above with reference to FIG. 2.

During consumption of the content, users may comment in a group space, they may share information with and make recommendations to others, and they may live screen themselves, as depicted at block 34. As noted above, a “live screen” operation may include sharing a visual representation of the user's computer display with other users in the group, sharing live video data, audio data, or both, captured from the user's environment, or a combination of these and other data sharing technologies that are generally known in the art. These features allow for greater amounts of interaction between and amongst consumers of the content in real-time, as the content is being consumed collectively, though remotely.

During and/or after consumption of the content, ratings and recommendations be generated by one or more users who shared the experience as indicated at block 35. As noted above, the amount of time each user spent watching the recommended content may be tracked, calculated, or otherwise determined by the Integrated System to generate additional data regarding the value of the content, the value of the recommendation, the manner in which each user's credits or loyalty points may be affected, and so on.

Within the Integrated Platform, each user may be provided with an option of following as many other users as desired, or of browsing other users' profiles, home pages, curated content, recommendations, and the like without electing to follow. In the example of FIG. 1, user 12 is depicted as following user 11, and thus may be enabled to observe that user 1 has rated several shows as described above. Any number (“n”) of users may search via appropriate software scripts executing at the Integrated Platform. A browser or search may find user 1, user 2, or user “n,” and may observe profiles or home pages to identify associated curated content and to determine the scope and nature of content that is being consumed or curated by other individuals with a circle of relationships between the users.

In some implementations, click-tracking, keystroke logging, and other behavioral identification techniques may observe such interactions, for instance, to allow a recommendation engine to focus on specific types of content (sporting events, romantic comedies, classical music, etc.), particular user profiles or demographics, highly rated content, etc. that may be of interest to a particular user. Software scripts, daemons, or other instructions sets running at the Integrated Platform may monitor and record all (or a subset of all) user interactions with the system, itself, with curated content, with recommendations, and with other users, for instance, to seed AI learning algorithms, machine learning algorithms, or other heuristics. The more the user interacts on the Integrated Platform, the more data may be accumulated regarding the user's behaviors, tendencies, and preferences; these may be used not only to customize or to optimize the user's experience on the Integrated Platform, itself, but may also have independent economic value outside of the context of the Integrated Platform. For example, in the foregoing manner, the Integrated Platform may aggregate a tremendous amount of data associated with each user—likes, dislikes, spending habits, the scope of the user's social network, the influence the user has over other users (e.g., as determined by the number of users acting upon recommendations, consuming the content in its entirety, and subsequently submitting concurring recommendations). Where such data are acquired on an enterprise level such as in the context of the Integrated Platform, the aggregated data may be employed to identify content consumption trends, to estimate user activity or tendencies based upon past behavior, gender, age, some other demographic criterion (or a combination of these and others), to identify reactions to advertising campaigns (again, by demographic categories), and the like. These data may be used by the Integrated Platform to optimize or otherwise to adjust services, to balance loads amongst server resources, to negotiate license or advertising agreements, and the like. These data may also have value to third-party service providers, as well. The Integrated Platform is in a unique position to acquire and to maintain such aggregated data from both a social network paradigm and a media consumption paradigm.

In certain implementations, particularly those making use of the aggregated data described above, the Integrated Platform may make recommendations, instead of or in addition to relying upon users to make recommendations. For example, a user's profile may identify several different genres of content that are of general interest, and may provide curated content categorized in those or other genres. The Integrated Platform, itself, may be able to ascertain the nature of the curated content (such as by key-stroke logging, click-tracking, or otherwise monitoring the user's interaction with the system) and, may, without bidding by the user, seek out, identify, and present similar content to the user, either with or without recommendations from the system of from other users.

In that regard, in FIG. 5, a user profile or home page 17 is depicted as having, displaying, or both, three curated programs 51, 52, and 53. Each of these curated programs is depicted as having a separate (though possibly overlapping) list of additional curated programming 54, 55, and 56. Additional programming, in this context, is programming or other content that is found to be similar to the curated content identified by the user. For example, programming 51 and programming 54 are similar to each other, and programming 52 and programming 55 are similar to each other. This may be because the content and the additional content are in the same genre, because the same production company is responsible for the works, the casts are similar or the lead actor is the same, or the like.

In some implementations, the additional curated programming 54, 55, and 56 flow from, or be related to, content curated by friends of the user or other trusted network contacts. Additionally or alternatively, however, as noted above, the additional curated programming 54, 55, and 56 that is being recommended or identified as of interest to the user may be content that is recommended by AI engines or other software processing running on the Integrated Platform, itself, and may be informed or influenced by user interaction with the system and with other users and content.

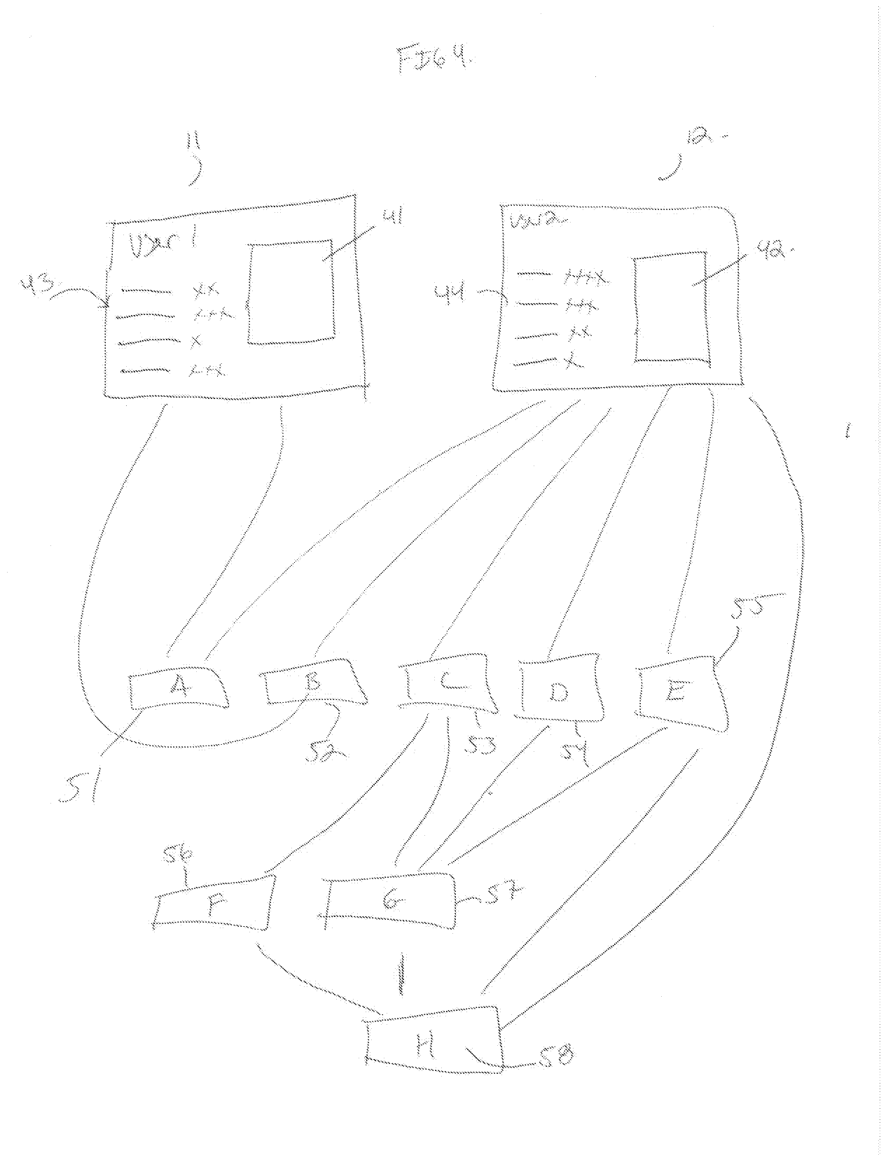

FIG. 4 is a high-level functional block diagram illustrating elements of one implementation in accordance with which users of an integrated social network and media streaming platform are enabled to find and to access content of another user. Specifically, FIG. 4 illustrates some aspects of an element of foregoing process, wherein user 11 and user 12 have profiles with certain curated content, e.g., content 43 and content 44. As displayed for browsing and selection, each of the various items of content identified in the users' profiles may have associated text, images, and/or ratings that may be visible to one or both of the curator and those reviewing the curated content. Thumbnail images, titles, brief text descriptions, “emojis” or other icons, and the like may be presented to viewers of the curated content to enable identification of and inference regarding the curator's or others' views or opinions of the value of the content.

As noted above, the content itself and the profile or home pages of the users can be viewed by others, provided at appropriate permissions to do so are granted by the curator of the content (i.e., a public profile, instead of a private profile). Users 51, 52, 53, 54, and 55 each may be permitted to view and interact with a profile for user 12. User C 53 is depicted as having additional downstream users 56 and 57, who are enabled to view content through user C 53, and subsequently, user F 56 may allow user H 58 to access content through the levels of users illustrated as a tree structure in FIG. 4.

In an implementation of the Integrated Platform, there may be any number, “n,” of users on the system, and any individual user may be enabled to find content being (or having been) consumed or curated by another through an unlimited number of layers or tiers in such a tree structure. In the example illustrated in FIG. 4, the content 41 or 42 may be seen by individuals downstream of the curating user 11 or user 12, provided that the curating user has provided appropriate permissions and that the downstream user is a subscriber to the appropriate media streaming platform (or a suitable proxy or alternative, as set forth above with reference to FIG. 2). In this manner, individual user C 53 may be permitted to access content 42 via user 12, and user G 57 may also be permitted to access content 42, though this time through user C 53. Furthermore, user H 58 may be permitted access to content 42, and this is through user G 57, who gains access through user C 53 and back to user 12.

As set forth above, the Integrated Platform may also have the capability to make recommendations related to, for example, which users to follow, which programs or content to view, and which recommendations are or may be most accurate or honest. Also as noted above, an recommendation engine at the Integrated Platform may be driven by AI learning or other heuristics trained by and optimized for a particular user's interactions with the system, the content, and other users. In some implementations, the Integrated Platform may provide information regarding such recommendations to a user, and may, for instance, send push notifications (i.e., unbidden) when a following party likes, dislikes, or otherwise comments on content that is curated or recommended by the user. Additionally or alternative, the system may employ a pull notification, which requires the user to request pending notifications; in this instance, the act of requesting the notification amounts to more interaction between the user and the system, enabling the AI features to ascertain more information from the user to be aggregated—for example, the system may infer that a user that requests notifications every few hours is more engaged than a user that requests notifications every few days, and can, for example, allocate resources more efficiently.

Referring back to FIG. 1, recall that user 12 may elect to watch a program recommended by user 11. When user 12 selects that program within the Integrated Platform, the system may index or check the program, for example, by title, metadata, subscription level, etc., against the content available to user 12 via subscriptions with applicable streaming media platforms 15 and cable, satellite, or other television providers 16. By way of example, suppose that user 12 has elected to watch an episode of How I Met Your Mother. User 12 has connected Amazon Prime™, NetFlix™, and Comcast™ accounts to the Integrated Platform, and provided user credentials or other information sufficient for the system to use appropriate APIs to access account information, viewing history, subscription level, and other data regarding the accounts at these third party providers associated with user 12. The Integrated Platform may access these account and content details (again, via appropriate APIs), and determine that How I Met Your Mother will be broadcast in syndicate on two different channels, and also determine that user 12 may access these shows at the time they air via a Comcast™ cable account. The Integrated Platform may send user 12 a push notification reminder to watch the program at the associated air time, or may inform user 12 of multiple air time and channel options. The Integrated Platform may also detect that the program is available for purchase on Amazon Prime™ and provide user 12 the option to purchase the program via the appropriate account. Additionally or alternatively, the Integrated Platform may also determine that the program streams on Hulu™ with a paid subscription, and may offer user 12 the option to purchase an appropriate account via the system. User 12 may then select one of these options for accessing the content, available across multiple platforms, using a single sign-in, central Integrated Platform. During operation, while user 12 is consuming content, the Integrated Platform continues to overlay on the streaming media, so that user 12 may invite others to watch the content live (i.e., as user 12 is viewing it), share the content with friend, network contacts, or other users of the system, and comment on and review the content, either live or at a later time.

In a second example, assume that user 12 selects another program that is recommended by user 11, Friends. The Integrated Platform searches user 12's connected accounts (as noted above), and detects that Friends is available on a particular media streaming platform. In this case, the Integrated Platform may automatically direct user 12 to this program, and continues to overlay on the stream, so that user 12 may invite others to watch, just as above.

As set forth herein, there is a significant and unmet need to identify new mechanisms to curate content and to create platforms for reliably sharing recommendations and curated content with others.

Responsive to this need, the disclosed Integrated Platform represents a consumption platform for the new media age, where users' curated content, consumption and interaction histories, and profiles are “channels” for other users to “flip” between to tune into content that is curated by friends, family, and tastemakers.

Those of skill in the art will appreciate that one useful aspect of the disclosed subject matter is the ability to identify curated content at the ready, removing or substantially reducing the current and escalating challenges associated with selecting appropriate media for consumption. Furthermore, an Integrated Platform creates a new community and new relationships centered on watching programming while simultaneously engaging with one another to experience the content together rather than in isolation. Such experiences are invaluable to revive the faultering community aspect of content consumption.

In another aspect, an Integrated Platform may facilitate or accommodate auto enabling connected devices upon sign up or giving authorization to enable Bluetooth™ or air-access to personal connected devices. For example, a user's device or computer that is connected to the Integrated Platform may automatically identify, or “read,” the presence of other such devices operated by other users in the same room or within a certain range. Such communications may be through Bluetooth™ as noted above, or via any other suitable near-field communications protocol with the capability to allow devices to communicate. In this manner, for instance, any device with suitable connection capabilities may detect the devices operated by other users of the Integrated Platform within a particular range, and may be able to give or to receive curated suggestions to or from multiple users in a space.

In accordance with one aspect as noted above, consuming content, creating content, and interacting with the system, or some combination of these and other actions, may provide the user with credits or currency. Accordingly, a user may agree that any or all actions, interactions, and activity with, on, or via the platform may be mined for data, and such a user may be awarded currency or credits based upon habits, use history, and other activity conducted on the system. Also as noted above, the more a particular user engages in activities on the system, the more data are aggregated, and the more focused, customized, or optimized the services provided to that user (and to others) may be; incentivizing more interaction, therefore, benefits both the users as well as the operator of the Integrated Platform.

In further implementations, a user may also allow or authorize a profile or home page associated with the user to be mined, and data may then be collected from the page, such that the content, curation, and visitors can be monetized. Additionally or alternatively, the user may provide specialized permissions or authorization that allows software running on the Integrated Platform to mine other data associated with the user, e.g., data maintained on a computer, mobile device, smart appliance, or other component owned by, operated by, or storing data on behalf of, the user (such data may include, without limitation, information and data records associated with contact lists, text messages, electronic mail content, photographs, metadata, and the like). By granting such specialized permission or authorization, the user may allow the Integrated Platform to access personal information outside of the context of a third party media streaming platform, for instance. This may be useful in the registration process, for example, to populate personal data and lists of friends into the user's profile or home page, and it may be useful for aggregation and monetization of the data, as set forth herein. As noted above, the more data that are available to the system, the more useful the AI features and overall system functionality may become.

For example, the user's data may be monetized by selling the data to provide revenue for new or targeted (i.e., location-based or context-sensitive) advertisements, for instance, or to extend discounts or rebates to new or additional users; conversely, revenue from user activity or sale of user data may be used to provide advertising-free content to active users, for example, or for a variety of other purposes as the operator of Integrated Platform sees fit. It will be appreciated that such a revenue source may also generate currency or other value to the user, as well. Access to advertising-free content, as noted above, is one example, but it is also contemplated that a user may be enabled to earn, for instance, subsidized subscription benefits commensurate in scope with the user's activity (and thus volume of data) on the system. Such a benefit may assist the users with handling the rising costs of content as platforms or providers get more and more oversubscribed.

In a further use case, a user profile or home page may have recommended content that is directed to a private room. In such private rooms, invited or selected users may freely share content and video feeds among one another. Such private rooms may be embodied in or implemented as “secret” private rooms, i.e., other users of the Integrated Platform may not even know that the room exists unless they are directly invited by a secret private rooms organizer or founding user; conversely, the Integrated Platform may also host a “public” private room, i.e., the room may be recommended to others, but access may be provided based upon some consideration, including payment for access, a vote by the current members, a candidate user's activity, the quality of a candidate user's curated content or recommendations, or a combination of these and other factors, which may be public private room-specific.

In certain situations, private rooms may include both live-streaming content as well as previously recorded and stored content; as noted above, the users within the private rooms may be able to communicate and interact with one another as a feature of each instantiation of the room.

In accordance with feature set forth above, the system and platform may enable users both to create content and to aggregate content. Specifically, with regard to content curation or content aggregation, the ability to identify a universe of content, to identify any fees associate with or necessary for access to the universe of content, and to be directed to such content in a curated way is addressed by the Integrated Platform in an organic way that gracefully combines social network functionality with content streaming functionality. By storing such content and data regarding users' interactions with the content and with each other within a searchable database, both users and operational components of the system may seamlessly identify, aggregate, curate, consume, and monetize (as the case may be) content and its associated data in a new way. Furthermore, with regard to content curation, users are typically the best sources of generating content (such as recommendations and review materials) for use by other users, and are typically the best at curating content (and the associated data attendant with the curation process). This is usually because users tend to interact with one another in ways that machines cannot, and because users are able to understand subtle social cues that are difficult to define in an algorithmic or AI approach. Notwithstanding that reality, however, mining data related to or arising from those user actions and interactions is best suited for software or AI algorithms, which may be implemented as set forth above to capitalize on the wealth of data generated by ordinary use of the system.

Several features and aspects of a system and method have been illustrated and described in detail with reference to particular embodiments by way of example only, and not by way of limitation. Those of skill in the art will appreciate that alternative implementations and various modifications to the disclosed subject matter are within the scope and contemplation of the present disclosure. Therefore, it is intended that the present disclosure be considered as limited only by the scope of the appended claims.

What is claimed is:

1. An integrated platform comprising:
a profile management application that maintains a plurality of user profiles; each respective one of the plurality of user profiles associated with a respective user of the integrated platform and including data representative of permissions granted to the respective user enabling access to content on a media platform;
a permissions management application that determines the respective user's permissions, wherein the data enable identification of content from the media platform that is selectively available for consumption by the respective user; and
a curated content management application that maintains curated content, wherein each respective user is enabled to curate content from the media platform in the respective user profile and to engage in communications associated with recommendations regarding the content.

2. The integrated platform of claim 1, wherein the permissions management application checks content that is recommended to a respective user against the data to confirm available access for the respective user.

3. The integrated platform of claim 2, wherein the permissions management application confirms access when the permissions granted to the respective user provide permission to consume the content.

4. The integrated platform of claim 2, wherein, when the permissions granted to the respective user do not provide permission, the permissions management application denies access pending further action by the respective user.

5. The integrated platform of claim 1, further comprising a monetization application that enables the integrated platform to monetize the respective user's interactions with features.

6. The integrated platform of claim 5, wherein the interactions comprise providing user credentials for the integrated platform to collect the data, providing special permission for the integrated platform to collect other data associated with the respective user, curating content, consuming content, viewing advertisements, and engaging in communications associated with recommendations.

7. The integrated platform of claim 5, wherein the monetization application enables the integrated platform to monetize by providing to the respective user one of subscription rebates, free or subsidized access to content, reduced advertising or advertising-free content, or cash rewards.

8. The integrated platform of claim 6, wherein the monetization application enables the integrated platform to monetize by selling the data, the other data, or both.

9. The integrated platform of claim 1, further comprising a consumption application that enables the curated content in the respective user's profile to be consumed by an arbitrary number of other respective users simultaneously.

10. The integrated platform of claim 9, wherein the consumption application enables any respective user to provide a live feed to the other respective users as the curated content is being consumed.

11. The integrated platform of claim 1, further comprising a data mining application that enables the integrated platform to retrieve at least one of use data from the media platform and device data from a device associated with the user.

12. The integrated platform of claim 11, wherein the profile management application stores the use data and the device data in the respective user's profile.

13. The integrated platform of claim 11, further comprising a monetization application that enables the integrated platform to monetize the use data, the device data, or both.

14. A system of organizing and monetizing user data, the system comprising:
a computer server hosting an integrated platform, the server comprising:
a processing component; and
a memory component comprising instruction sets to enable functionality of the integrated platform, and
a database operatively coupled to the server and having access to the memory component;
wherein the integrated platform is operatively coupled to the memory component and to the database, and comprises:
a profile management application that maintains a plurality of user profiles; each respective one of the plurality of user profiles associated with a respective user of the integrated platform and including data representative of permissions granted to the respective user enabling access to content on a third party media platform;
a permissions management application that determines the respective user's permissions, wherein the data enable identification of content from the third party media platform that is selectively available for consumption by the respective user;
a curated content management application that maintains curated content, wherein each respective user is enabled to curate content from the media platform in the respective user profile, to engage in communications associated with recommendations and consumption regarding the content, and to present the respective user's curated content and live feeds in a channel format to other respective users; and
a data mining application that enables the integrated platform to retrieve at least one of use data from the third party media platform and device data from a device associated with the user, wherein the use data and the device data are stored in the database.

15. The system of claim 14, wherein the integrated platform further comprises a monetization application that enables the integrated platform to monetize the use data, the device data, or both.

16. The system of claim 14, wherein the integrated platform further comprises a recommendation application that employs the respective user's interactions to recommend content to the respective user.

17. The system of claim 16, wherein the recommendation application allows the respective user to provide a recommendation of content to other respective users and employs the other respective users' interactions to assess a value of the recommendation.

18. A method of organizing and monetizing user data, the method comprising:
maintaining a plurality of user profiles in a memory component accessible by an integrated platform; each respective one of the plurality of user profiles associated with a respective user of the integrated platform and including data representative of permissions granted to the respective user enabling access to content on a third party media platform;
retrieving at least one of use data from the third party media platform and device data from a device associated with the user;
populating the respective user profile with the use data and the device data;
identifying content from the third party media platform that is selectively available for consumption by the respective user;
responsive to the identifying, allowing the respective user to consume and to curate content from the third party media platform in the respective user profile and to engage in communications associated with recommendations regarding the content; and
responsive to the allowing, monetizing the use data and the user data.

19. The method of claim 18, further comprising allowing the curated content in the respective user's profile to be consumed by an arbitrary number of other respective users simultaneously.

20. The method of claim 19, further comprising allowing any respective user to provide a live feed to the other respective users as the curated content is being consumed.
